(19) United States
(12) Patent Application Publication
(10) Pub. No.: US 2016/0129886 A1
(43) Pub. Date: May 12, 2016

(54) Heated Windshield Wiper

(71) Applicant: Gregory Starks, Raymond, OH (US)

(72) Inventor: Gregory Starks, Raymond, OH (US)

(21) Appl. No.: 14/925,082

(22) Filed: Oct. 28, 2015

Related U.S. Application Data
(60) Provisional application No. 62/076,530, filed on Nov. 7, 2014.

(51) Int. Cl. B60S 1/38

(52) U.S. Cl. CPC B60S 1/3805

(57) ABSTRACT

A heated windshield wiper for helping to remove ice and snow from a vehicle windshield. The heated windshield wiper includes an elongated support for connection to a windshield wiper arm. The elongated support includes one or more fasteners for receiving a wiper blade thereon. The wiper blade preferably has an X-shaped cross section and further includes a heating element thereon. The heating element preferably includes a tubular member that contains a fluid that can be electrically heated so as to increase the temperature thereof and provide heat to the wiper blade. A power source is contained in a separate housing, wherein the power source is electrically connected to the heating element of the wiper blade.

### CROSS REFERENCE TO RELATED APPLICATION

This application claims the benefit of U.S. Provisional Application No. 62/076,530 filed on Nov. 7, 2014. The above identified patent application is herein incorporated by reference in its entirety to provide continuity of disclosure.

### BACKGROUND OF THE INVENTION

### Field of the Invention

The present invention relates to a heated windshield wiper. More specifically, the present invention provides a heated windshield wiper comprising an elongated support adapted to be removably secured to a windshield wiper arm. The elongated support also engages with a wiper blade having a heating element thereon. The heating element is preferably an elongated tube containing a fluid that can be electrically heated.

During periods of cold weather, snow and ice can accumulate on vehicle windshields and windshield wipers. Many people spend time clearing the snow and ice off of their windshield prior to driving, however, it can be difficult to fully remove all of the snow and ice on the vehicle. Ice or snow that remains on the windshield wipers may cause the windshield wipers to fail to function properly, resulting in streaking or smearing. Further, accumulation of ice or snow on the windshield wipers may damage the wiper and wiper blades, requiring the wipers to be replaced. Thus, a heated windshield wiper is desired that helps to remove snow and ice from the windshield.

Devices have been disclosed in the prior art that relate to heated windshield wipers. These include devices that have been patented and published in patent application publications. These devices generally relate to heated windshield wiper blades that include a wiper with various types of heating elements thereon, such as U.S. Pat. No. 6,058,554, U.S. Patent Application Publication No. 2012/0005856, U.S. Pat. No. 5,787,543, and U.S. Pat. No. 6,236,019.

These prior art devices have several known drawbacks. The devices in the prior art relate to heated windshield wipers but fail to provide a windshield wiper having an elongated support adapted to removably receive a wiper blade thereon, wherein the wiper blade comprises an elongated tube filled with a fluid that can be electrically heated so as to provide heat to the windshield.

In light of the devices disclosed in the prior art, it is submitted that the present invention substantially diverges in design elements from the prior art and consequently it is clear that there is a need in the art for an improvement to existing heated windshield wiper devices. In this regard the instant invention substantially fulfills these needs.

### SUMMARY OF THE INVENTION

In view of the foregoing disadvantages inherent in the known types of heated windshield wipers now present in the prior art, the present invention provides a new heated windshield wiper wherein the same can be utilized for providing convenience for the user when removing snow and ice from a windshield.

It is therefore an object of the present invention to provide a new and improved heated windshield wiper comprising an elongated support removably securable to a windshield wiper arm and adapted to receive a wiper blade thereon.

It is another object of the present invention to provide a heated windshield wiper comprising a wiper blade having a heating element thereon, wherein the heating element comprises an elongated tube having an electrically heatable fluid therein.

Another object of the present invention is to provide a heated windshield wiper comprising a wiper blade having an X-shaped cross section.

Yet another object of the present invention is to provide a heated windshield wiper having a power source electrically connected to an elongated support on which a wiper blade having a heating element is secured so as to provide electrical current to the heating element.

Another object of the present invention is to provide a heated windshield wiper that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the heated windshield wiper.

FIG. 2 shows an end view of the heated windshield wiper.

FIG. 3 shows a view of the heated windshield wiper as installed on a vehicle.

### DETAILED DESCRIPTION OF THE INVENTION

Reference is made herein to the attached drawings. Like reference numerals are used throughout the drawings to depict like or similar elements of the heated windshield wiper. For the purposes of presenting a brief and clear description of the present invention, the preferred embodiment will be discussed as used for removing snow and ice from a vehicle windshield. The figures are intended for representative purposes only and should not be considered to be limiting in any respect.

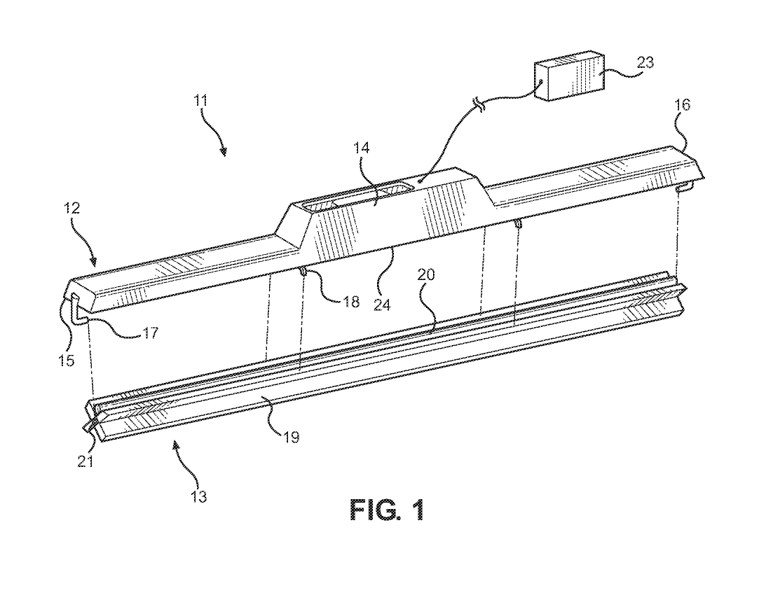

Referring now to FIG. 1, there is shown a perspective view of the heated windshield wiper. The windshield wiper 11 comprises an elongated support 12 adapted to be removably secured to a windshield wiper arm of a vehicle. The elongated support 12 comprises an upper portion and a lower portion, wherein the windshield wiper arm is removably securable to the upper portion 14 thereof. The lower portion of the elongated support 12 comprises blade connectors 17 on opposing ends 15, 16 thereof. The blade connectors 17 preferably comprise hooks having inwardly turned ends as shown in the illustrated embodiment. The blade connectors 17 are adapted to removably secure to the ends of a wiper blade 13 so that the wiper blade 13 is positioned along the length of the elongated support 12. In this way, the wiper blade 13 and elongated support 12 are substantially parallel to one another and are connected along the length thereof.

The lower portion further comprises one or more clips 18 for securing to the heating element 20 of the wiper blade 13. The clips 18 preferably have a C-shaped cross section so as to receive the heating element 20 in the interior thereof. The clips 18 are arranged on the lower portion of the elongated support 12 and are disposed along the length thereof. In this way, the blade connectors 17 secure the ends of the wiper blade 13 and the clips 18 secure the central or mid-portions of the wiper blade and heating element.

The wiper blade 13 comprises an elongated configuration and includes one or more blades 19 thereon. In the illustrated embodiment, the wiper blade 13 comprises an X-shaped cross section such that it has four blades 19. The wiper blade 13 further comprises a heating element 20 thereon. Preferably, the heating element 20 is a tubular member having a hollow interior volume. The tubular member encloses a heatable fluid therein, wherein the fluid is adapted to be heated when electrical current is supplied thereto. In this way, the heating element 20 can be selectively heated by supplying electrical current to the tubular member.

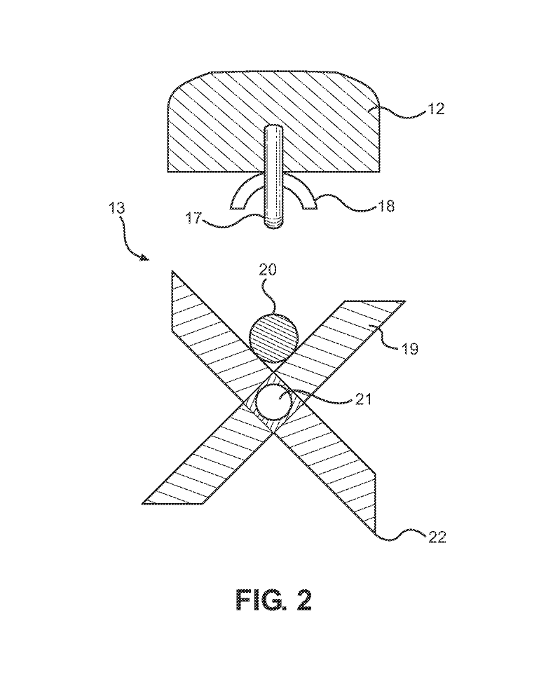

Referring now to FIG. 2, there is shown an end view of the heated windshield wiper. The wiper blade 13 preferably comprises an X-shaped cross sectional area, wherein four blades 19 extend radially outward from a central point. The wiper blade 13 can be rotated so that any of the four blades 19 is in contact with the windshield of the vehicle. In this way, once a blade 19 wears down or becomes damaged, the user can rotate the wiper blade 13 so as to place one of the other blades 19 in contact with the windshield. Each end of the wiper blade 13 comprises an opening 21 adapted to removably receive a connector 17 of the elongated support 12 therein so as to secure the wiper blade 13 in a fixed position, preventing the wiper blade 13 from rotating during use. The connector 17 can be inserted into the opening 21 so as to secure the wiper blade 13 to the elongated support 12. Further, the connectors 17 electrically connect the wiper blade 13 to the elongated support 12 so that electricity is provided to the heating element 20 and the fluid therein.

The heating element 20 is positioned on the wiper blade 13, and is preferably positioned along the longitudinal axis of the wiper blade 13. In the illustrated embodiment, the heating element 20 is positioned between a pair of blades 19. The elongated support 12 further comprises one or more clips 18 that engage with the heating element 20 itself so as to secure the heating element 20 to the elongated support 12. The clips 18 removably engage with the heating element 20 so as to stabilize the same and ensure that the wiper blade 13 does not separate from the elongated support 12. Further, the clips 18 are composed of a heat resistant material so that the heating element 20 does not burn, melt, or otherwise damage the fasteners 18.

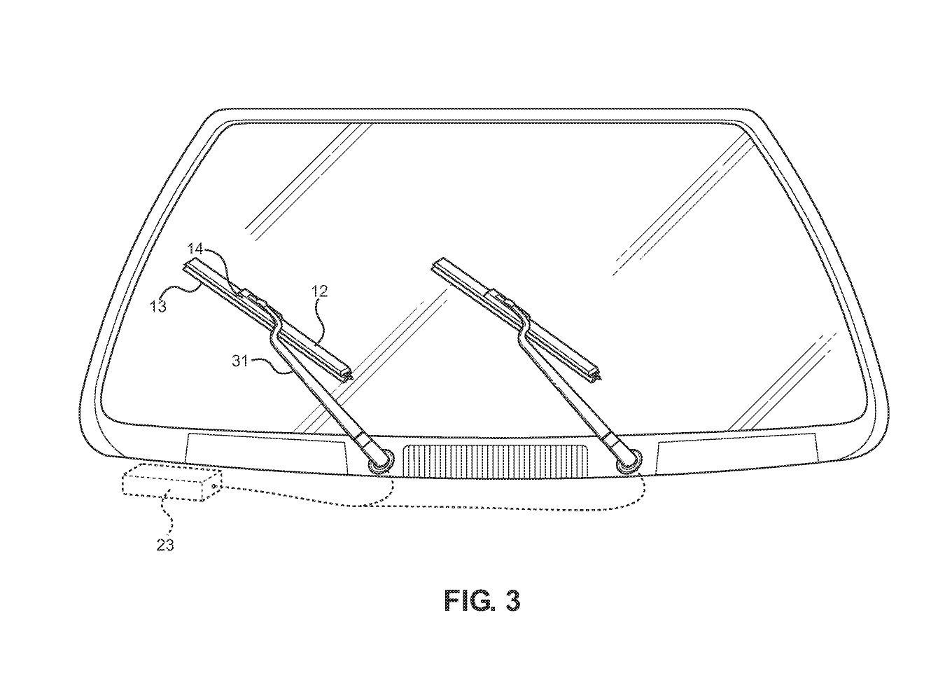

Referring now to FIG. 3, there is shown a view of the heated windshield wiper as installed on a vehicle. In operation, the elongated support 12 of the heated wiper blade device 11 can be removably secured to the windshield wiper arm 31 of a vehicle. The windshield wiper arm 31 is secured to the upper portion 14 of the elongated support 12 via any conventional fastening methods, such as engagement of a hook on the arm 31 with a clasp or hook or the elongated support 12. A wiper blade 13 is removably secured to the lower portion of the elongated support 12 and extends along the length thereof. Connectors on opposing ends of the elongated support 12 engage with openings on the ends of the wiper blade 13 so as to secure the elongated support 12 to the wiper blade 13.

A power source 21 is preferably enclosed within a separate housing, and the power source 21 can be secured on the vehicle adjacent to the windshield wipers. The power source 21 can be affixed using any conventional fastening methods, such as by means of adhesives, welding, or the like. The power source is electrically connected to the elongated support 12, which can in turn be electrically connected to the wiper blade 13 by engaging the connectors on the elongated support with the openings on the ends of the wiper blade 13. In this way electrical current is provided to the heating element on the wiper blade 13. The electrical current causes the temperature of the heating element to rise, so that the wiper blade can be used to melt snow or ice on the wipers or on the windshield.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A heated windshield wiper blade, comprising:
an elongated support having an upper end and a lower end;
wherein said upper end is adapted to engage with a windshield wiper arm of a vehicle;
a wiper blade removably securable to said elongated support;
a heating element disposed on said wiper blade.

2) The heated windshield wiper blade of claim 1, wherein said elongated support further comprises a first end and a second end, wherein said first end and said second end each include a connector thereon, wherein said connectors removably engage with said wiper blade.

3) The heated windshield wiper blade of claim 2, wherein said wiper blade comprises a first end and a second end, wherein each of said first end and said second end includes an opening thereon, wherein said openings removably receive said connectors on said elongated support.

4) The heated windshield wiper blade of claim 1, wherein said wiper blade comprises an X-shaped cross sectional area.

5) The heated windshield wiper blade of claim 1, wherein said lower portion of said elongated support comprises one or more clips that removably engage with said heating element.

6) The heated windshield wiper blade of claim 1, wherein said heating element comprises a tubular member having a hollow interior volume, wherein said interior volume contains a heatable fluid therein.

7) The heated windshield wiper blade of claim 1, further comprising a power source electrically connected to said elongated support, wherein engagement of said elongated support with said wiper blade provides electrical current to said heating element of said wiper blade.
